(19) United States
(12) Patent Application Publication
(10) Pub. No.: US 2013/0099086 A1
(43) Pub. Date: Apr. 25, 2013

(54) BUMPER MOUNTED HOLDER FOR A HIGH-LIFT JACK

(71) Applicant: Nicholas Charles Jevne, Astoria, SD (US)

(72) Inventor: Nicholas Charles Jevne, Astoria, SD (US)

(21) Appl. No.: 13/277,650

(22) Filed: Oct. 20, 2011

(51) Int. Cl. F16M 13/00

(52) U.S. Cl. 248/511

(57) ABSTRACT

A holder for stabilizing a high-lift jack during the lifting of the vehicle. The holder includes a first section and a second section interconnected to the first section. The first section and the second section have complementary shapes. The first section is adapted to be secured to a vehicle. A rack of the high-lift jack is adapted to slip between the first section and the second section.

### BACKGROUND OF THE INVENTION

The present invention generally relates to a support notch for a high-lift jack. More particularly, the present invention relates to a holder for a high-lift jack's steel standard bar that is built into the bumper of a vehicle.

High-lift jacks are currently used for lifting heavy objects such as vehicles. High-lift jacks generally include an elongated rack, a support base, a ratchet assembly operated by a handle, and a lift assembly which is attached to the vehicle frame. Unfortunately, known high-lifting jacks often fall off the vehicle due to uneven ground, lack of a stable position beneath the vehicle frame, or jack product failure. For this reason, it is common practice to place rigid supports (jack stands) under the vehicle to prevent the vehicle from falling, in case the jack loses lifting force.

As can be seen, there is a need for a holder for stabilizing a high-lift jack during the lifting of a vehicle.

### SUMMARY OF THE INVENTION

In one aspect of the present invention, a holder includes a first section and a second section interconnected to the first section, the first section and the second section have complementary shapes, the first section is adapted to be secured to a vehicle, and a rack of the high-lift jack is adapted to slip between the first section and the second section.

In another aspect of the present invention, a holder for a high-lift jack includes a first section, the first section includes a main body having an upper end, a lower end, a first side flap, a second side flap, an orifice on the upper end, a hole on the lower end, a flange protruding from the lower end, and a recess on the flange; a second section interconnected to the first section, the second section includes a central frame having a first side plate, a second side plate, the side plates are separated from each other forming a canal, a cam pin is placed between the side plates, each side plate includes an arm protruding from an upper end, and the arms are separated from each other forming a slot; the cam pin is secured to the recess; in an assembled position the cam pin is secured to the recess, the channel is vertically aligned with the slot, the main hole is horizontally aligned with the hole, a fastener is slipped through the main hole and the hole to secure the first section to the second section together.

These and other features, aspects and advantages of the present invention will become better understood with reference to the following drawings, description and claims.

### BRIEF DESCRIPTION OF THE DRAWINGS

FIG. 1 illustrates a perspective front view of a holder for a high-lift jack according to an exemplary embodiment of the present invention showing the jack mounted on a bumper of a vehicle;

FIG. 2 illustrates a perspective front view of the holder of FIG. 1;

FIG. 3 illustrates a side view of the holder of FIG. 1;

FIG. 4 illustrates a perspective front view of a first section of the holder of FIG. 1;

FIG. 5 illustrates a side view of the first section of FIG. 4;

FIG. 6 illustrates a perspective side view of the first section of FIG. 4;

FIG. 7 illustrates a rear view of a second section of the holder of FIG. 1;

FIG. 8 illustrates a perspective front view of a second section of FIG. 7;

FIG. 9 illustrates a perspective rear view of the second section of FIG. 7;

FIG. 10 illustrates an exploded view of the holder of FIG. 1;

FIG. 11 illustrates a side view of the holder of FIG. 1 showing the holder in an assembled position; and

FIG. 12 illustrates a rear view of the holder of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a support notch for stabilizing a high-lift jack's steel standard bar during the lifting of a vehicle.

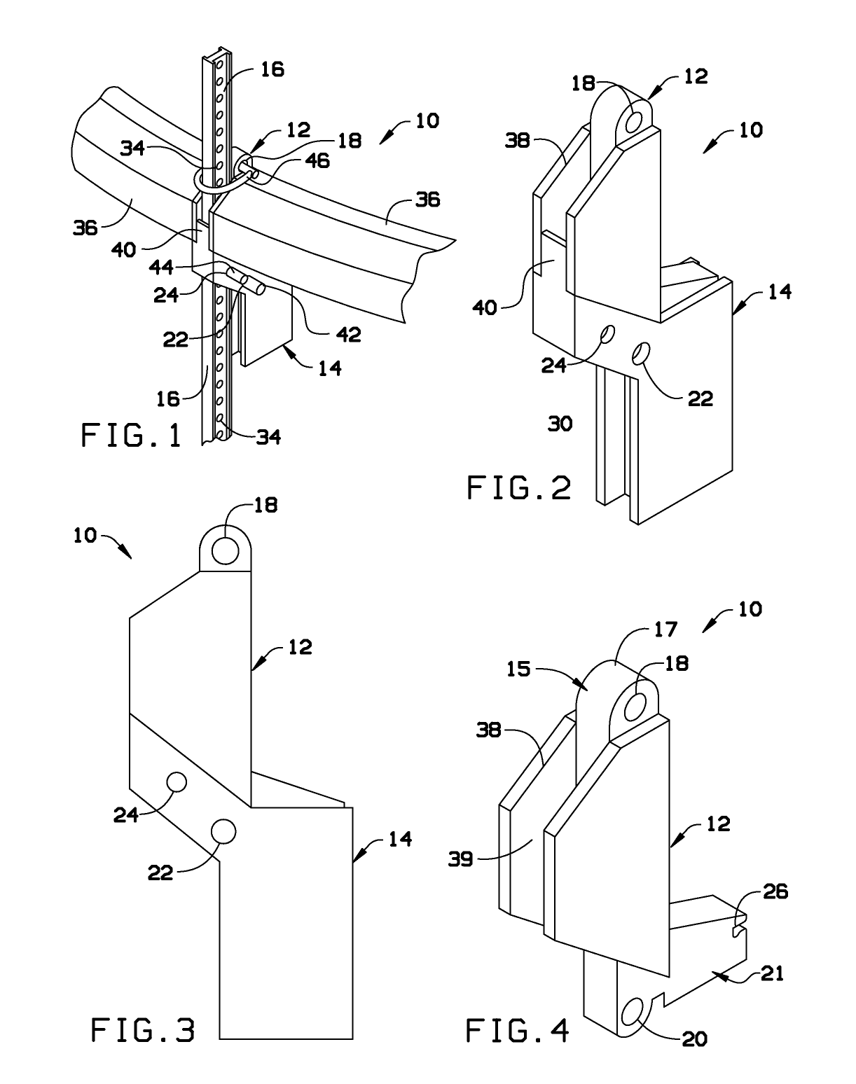

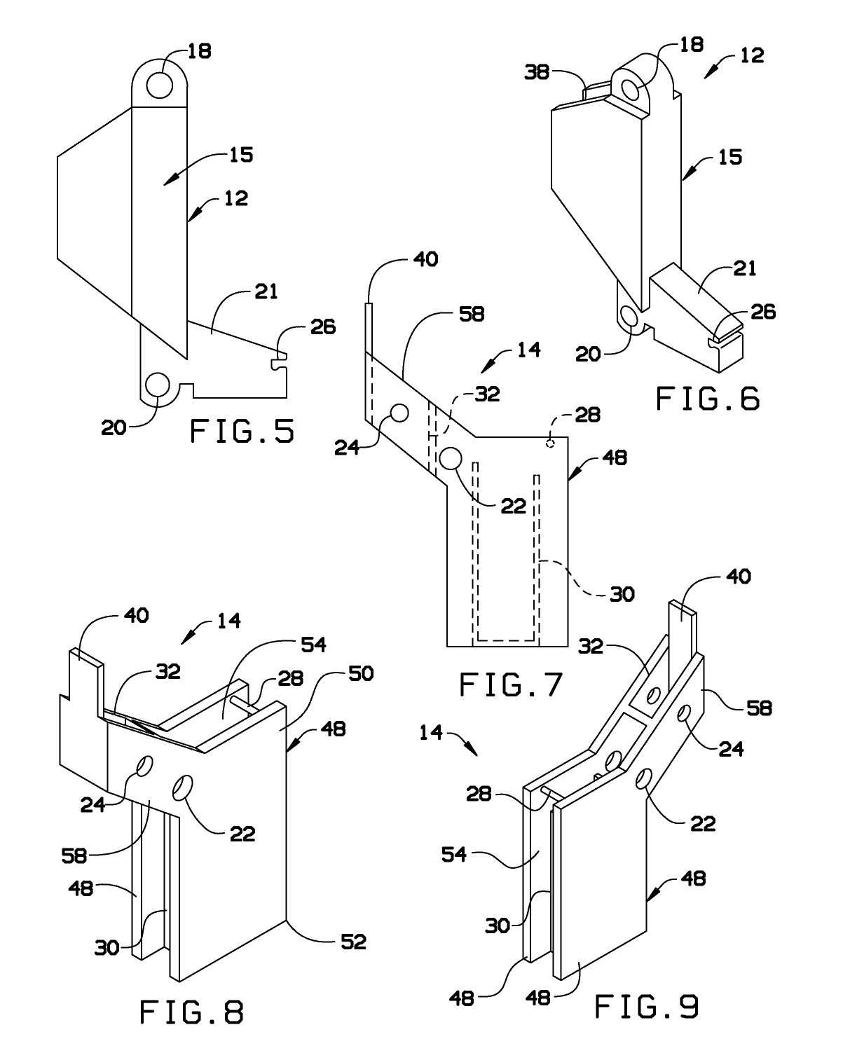

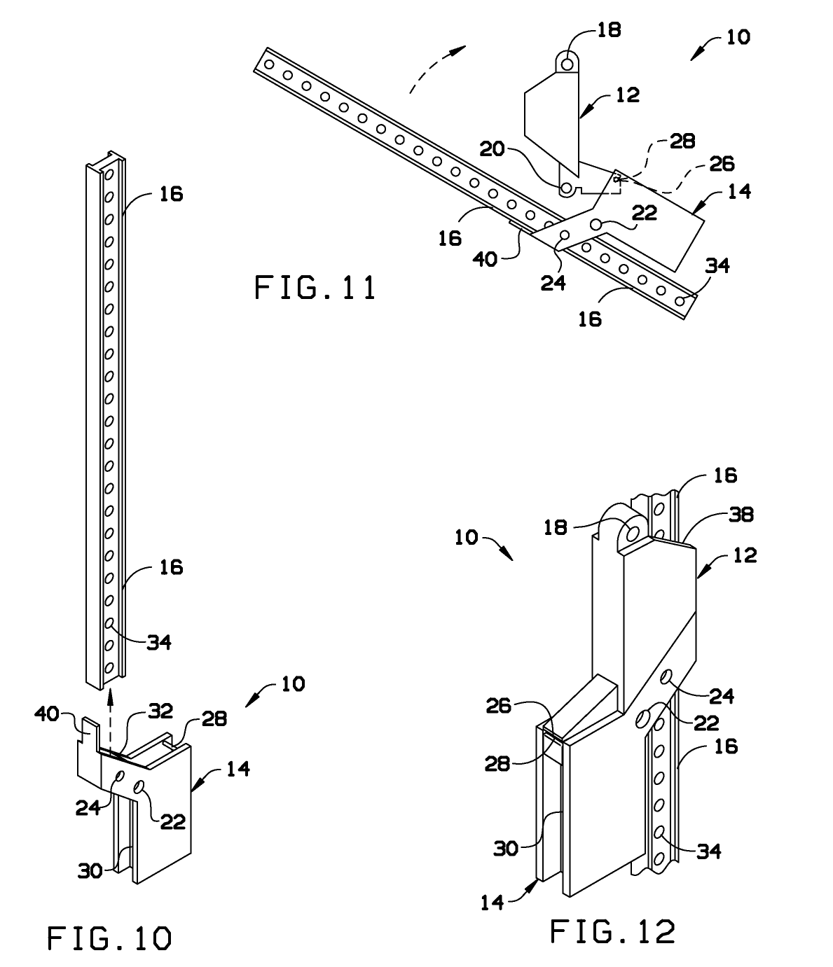

FIGS. 1-12 illustrate a holder 10 for a high-lift jack (not shown) according to an exemplary embodiment of the present invention. The holder 10 may be mounted on a bumper 36 of a vehicle (not shown) or attached to a receiver hitch (not shown). The holder 10 may provide the user (not shown) with a safe way to lift the vehicle (not shown) and at the same time eliminate the need for jack stands.

The holder 10 may include a first section 12 and a second section 14. The first section 12 may be interconnected with the second section 14 to secure a rack 16 of the high-lift jack (not shown) between them. The shape of the first section 12 and the second section 14 may be designed to accept and retain the rack 16. The shape of the first section 12 may complement the shape of the second section 14 to facilitate the interconnection. The first section 12 and the second section 14 may be made of a high strength and non-corrosive material, for example, steel, plastic, aluminum, composite, or polymeric material. The size of the first section 12 and the second section 14 may depend on the size of the rack 16 of the high-lift jack (not shown).

The first section 12 may be mounted to the bumper 36 or may be secured to the receiver hitch (not shown). In some embodiments, the first section 12 may be built into the bumper 36.

The first section 12 may include a main body 15 having an upper end 17, a lower end 19, and a pair of side flaps 38. The upper end 17 may include an orifice 18 adapted to receive a locking pin 46 of the hitch (not shown). The lower end 19 may include a hole 20 for receiving a fastener 42. The fastener 42 may be a commercially available fastener, for example, clevis, pins, bolts, or screws. A flange 21 may protrude from the lower end 19. The flange 21 may include a recess 26. The recess 26 may be connected to a cam pin 28 on the second section 14 in an assembled position. The pair of side flaps 38 may be separated from each other forming a channel 39. The rack 16 may be slipped through the channel 39.

The second section 14 may include a central frame 30 having side plates 48. The side plates 48 may be separated from each other forming a canal 54. Side plates 48 may be mirror images of each other. Each side plate 48 may include an upper end 50, a lower end 52, and an arm 56 protruding from the upper end 50. The arms 56 may be separated from each other forming a slot 32. Each arm 56 may include a main hole 22 and a secondary hole 24. A tongue 40 may be placed at the end of the arms 56. The tongue 40 may be slipped through the channel 39 of the first section when the sections 12, 14 are in the assembled position.

The cam pin 28 may be placed between the side plates 48. The cam pin 28 may be secured to the recess 26 of the first section 12.

The user (not shown) may secure the first section 12 to the bumper 36 of the vehicle by passing the locking pin 46 through the orifice 18 of the first section 12.

Then, the user may slip the flange 21 inside the canal 54 of the second section 14 until the cam pin 28 fits into the recess 26. Because of the design of the first section 12 and the second section 14, the channel 39 of the first section 12 may be vertically aligned with the slot 32 of the second section 14. The main hole 22 may be horizontally aligned with the hole 20 of the first section 12. The fastener 42 may be slipped through the main hole 22 and the hole 20 to secure the first section 12 to the second section 14 together. Then, the user may slip the rack 16 of the high-lift jack (not shown) into the channel 39 of the first section 12 and through the slot 32 of the second section 14. The secondary hole 24 may be aligned with an orifice 34 on the rack 16. A jack stand pin 44 may be passed through the secondary hole 24 and the orifice 34 to secure the rack 16 to the second section 14 at a desired vertical position.

The holder 10 may allow the user to safety lift the vehicle when using the high-lift jack without having to use jack stands.

It should be understood, of course, that the foregoing relates to exemplary embodiments of the invention and that modifications may be made without departing from the spirit and scope of the invention as set forth in the following claims.

What is claimed is:

1. A holder for a high-lift jack comprising:
a first section; and
a second section interconnected to the first section;
wherein the first section is adapted to be secured to a vehicle;
wherein the first section and the second section have complementary shapes; and
wherein a rack of the high-lift jack adapted to slip between the first section and the second section.

2. The holder according to claim 1, wherein the first section is integrated to the vehicle.

3. The holder according to claim 1, wherein:
the first section comprises a main body having an upper end, a lower end, and a pair of side flaps;
the upper end includes an orifice;
the lower end includes a hole;
a flange protrudes from the lower end; and
the flange includes a recess.

4. The holder according to claim 1, wherein:
the second section includes a central frame having a first side plate and a second side plate;
the side plates are separated from each other forming a channel;
the side plates are mirror images of each other;
each side plate includes an arm protruding from an upper end; and
the arms are separated from each other forming a slot.

5. The holder according to claim 4, wherein each arm includes a main hole, a secondary hole, and a tongue protruding from the arm.

6. The holder according to claim 5, wherein the tongue slips through the channel of the first section when the first section and the second section are interconnected.

7. A holder for a high-lift jack comprising:
a first section, wherein the first section comprises a main body having an upper end, a lower end, a first side flap, a second side flap, an orifice on the upper end, a hole on the lower end, a flange protruding from the lower end, a recess on the flange, the first side flap and the second side flap are separated from each other forming a channel;
a second section interconnected to the first section, wherein the second section includes a central frame having a first side plate, a second side plate, the side plates are separated from each other forming a canal, a cam pin is placed between the side plates, each side plate includes an arm protruding from an upper end, and the arms are separated from each other forming a slot;
wherein in an assembled position the cam pin is secured to the recess, the channel is vertically aligned with the slot, the main hole is horizontally aligned with the hole, a fastener is slipped through the main hole and the hole to secure the first section to the second section together.

8. The holder according to claim 7, wherein a rack of the high-lift jack slips through the channel and the slot.

9. The holder according to claim 7, wherein the first section is adapted to be secured to the vehicle.

10. The holder according to claim 7, wherein the first section is built into the vehicle.
